(19) United States
(12) Patent Application Publication
(10) Pub. No.: US 2015/0261189 A1
(43) Pub. Date: Sep. 17, 2015

(54) Wrist-Worn Device with Removable Head Unit

(71) Applicant: Google Inc., Mountain View, CA (US)

(72) Inventor: Emmett Connolly, San Francisco, CA (US)

(73) Assignee: Google Inc., Mountain View, CA (US)

(21) Appl. No.: 14/207,518

(22) Filed: Mar. 12, 2014

(51) Int. Cl. G04B 29/04; A41D 20/00

(52) U.S. Cl. CPC G04B 29/04; A41D 20/00

(57) ABSTRACT

A system including a wearable device such as a smart watch with a removable head unit is provided. The wristband of the system may be useable independently of the head unit, such as to collect data via a sensor while the head unit is disconnected. Upon reconnecting to the head unit, the head unit can analyze data collected by the wristband. Different wristbands may be used with a single head unit, such as to provide different sensors, additional capabilities, and the like.

### BACKGROUND

A “smart watch” or similar device typically includes several main components, such as a head unit that includes a processor and a display, a wrist strap that allows a user to wear the smart watch, and a charger that provides power to the smart watch, typically when the watch is not being worn by a user. Conventional smart watch configurations typically are limited in functionality compared to other mobile devices such as mobile phones or tablet computing devices, due to the desire to minimize the size of the head unit of the smart watch. Conventional smart watch systems also may have limited functionality when the device is not worn by a user, because it may be expected that a user will only wish to use the computing functionality of the smart watch when it is worn.

### BRIEF SUMMARY

According to an embodiment of the disclosed subject matter, a system is provided that includes a first wristband having a sensor; a head unit comprising a processor and a display, which can be connected to the wristband; and a docking station configured to receive the head unit when the head unit is disconnected from the wristband. The wristband may include a battery and/or other components, which may have different capacities and/or functionality than corresponding components in the head unit. The wristband may include multiple sensors and/or components, such as where a set of components is tailored for a particular use scenario. The wristband may include biometric or other sensors that can operate at a relatively low power when the wristband is disconnected from the head unit. The wristband may sync with the head unit when the head unit is connected to the wristband.

In an embodiment, the head unit may be removably connectable to a second wristband, which may include additional or different sensors and/or components relative to those in the first wristband.

In an embodiment, the docking station may be configured to charge the head unit and/or the wristband, such as via inductive charging components in each of the docking station, the head unit, and the wristband.

In an embodiment, a smart watch component is provided that includes a display; a processor in communication with the display; a computer-readable memory in communication with the processor; and a communication component in communication with the processor, in which the communication component is configured to receive data from a wristband when the smart watch component is connected to the wristband. The smart watch component may include a battery, which can be used to provide power from the battery to the wristband when the smart watch component is connected to the wristband.

Embodiments of the presently disclosed subject matter provide smart watch configurations that allow for flexibility in use scenarios and allow for more efficient data collection and analysis, as well as providing for user configurable features in the smart watch system. Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a system including a smartwatch according to an embodiment of the presently disclosed subject matter.

FIG. 2 shows a schematic representation of a smartwatch according to an embodiment of the presently disclosed subject matter.

### DETAILED DESCRIPTION

Embodiments of the presently disclosed subject matter provide systems that include a head unit that can be removably connected to one or more wristbands. Each wristband may include separate components that can function in the absence of the head unit, such as sensors, processors, batteries or charging components, and the like. Thus, the wristband may have separate functionality from the head unit, allowing each to perform different functions when connected and when disconnected, and for the wristband to perform different functions than the head unit when the two are disconnected. For example, a wristband as disclosed herein may include biometric sensors such as heart rate, blood pressure, or the like, which can collect data regardless of whether the wristband is connected to the head unit. When reconnected, the wristband may then provide collected data to the head unit for additional processing and/or analysis.

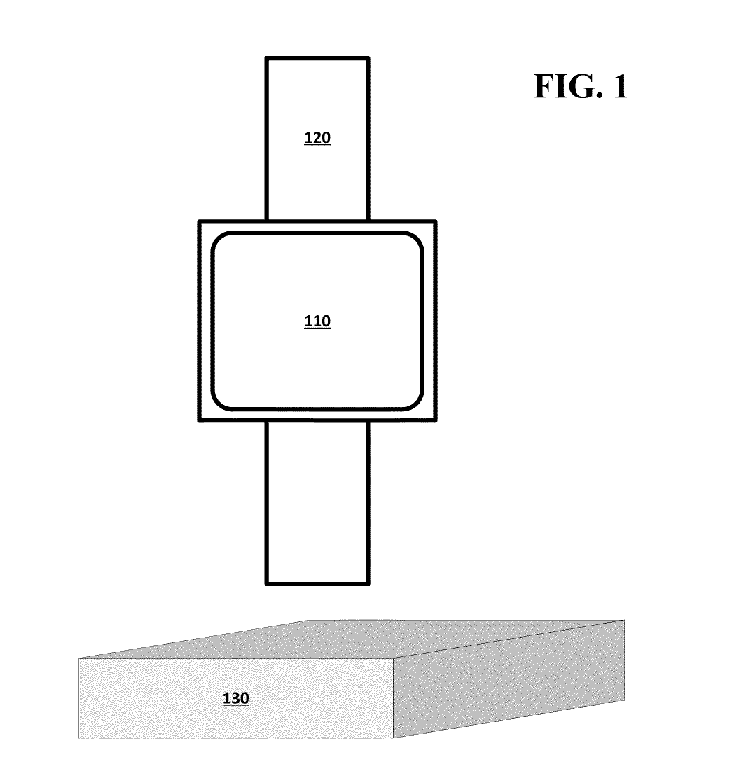

FIG. 1 shows an example system as disclosed herein. The system may include a head unit 110 and a wristband 120. The wristband may include one or more sensors, such as motion sensors, biometric sensors such as blood pressure, heart rate, pulse, and the like, electromagnetic sensors, positioning sensors, accelerometers, magnetometers, and the like. More generally, the wristband may include any suitable sensor, such as those that may be found in smart phones, tablet computing devices, and the like. The wristband also may include other components, such as a processor, a computer-readable memory, a wired and/or wireless communication component, and the like. Similarly, the head unit 110 may include a processor, a computer-readable memory, wired and/or wireless communication modules, a display, and the like. More generally, the head unit 110 may include components similar to those commonly found in other mobile computing devices such as smart phones and tablet computing devices. In some configurations, the head unit may have more computing power and/or storage than the wristband. For example, the head unit may include a processor that is faster than a processor in the wristband, a computer-readable memory that is larger than a memory in the wristband, a battery that has a larger capacity than a battery in the wristband, and the like.

When the head unit 110 and the wristband 120 are connected, the two may communicate via a wired communication, such as by way of an electrical connector that connects the head unit and the wristband, and/or via a wireless connection such as WiFi, Bluetooth(R), an RFID or near-field communication (NFC) connection, or any other suitable communication technique. Thus, when the two components are connected, the wristband may “sync” with the head unit by providing data stored in the wristband to the head unit, as will be readily understood by one of skill in the art. An electrical connection also may be made to allow the head unit and the wristband to transfer power from one to the other, thus allowing the head unit to provide electrical power to the wristband. Such a configuration may be useful to allow the wristband to include a lighter, thinner, or otherwise smaller battery that is used by the wristband when the wristband is not connected to the head unit, which then may be charged by the head unit when the head unit and the wristband are connected.

In some configurations, the wristband may collect data using one or more sensors as previously described when the wristband is not connected to the head unit. Data collected by the sensors may be stored in the wristband, and provided to the head unit when the two are connected. Such a configuration may allow for additional use cases that would be inconvenient or unlikely to be of interest to a user if a conventional smart watch was used. As a specific example, a user may wear only the wristband when sleeping at night or when exercising, to avoid damaging the head unit and/or to avoid the inconvenience of wearing a relatively larger and heavier watch. The wristband may collect data via one or more sensors while the user is sleeping or exercising, such as heart rate, skin conductivity, movement rate or frequency, or the like. When reconnected to the head unit, the wristband may provide this data to the head unit for further analysis or processing.

As a specific example, a user may wear the wristband while sleeping to determine if the user is particularly active during sleep and, therefore, does not receive as much rest as would otherwise be possible. When the wristband is reconnected to the head unit, the head unit may receive movement data collected by the wristband during the night. An application on the head unit may then collect, analyze, and/or present the data to the user, such as by showing times during which the user was particularly active. In contrast to a conventional smart watch or smart phone, such data may be obtained and analyzed without the user having to wear a relatively bulky device, or make arrangements for a separate device such as a smart phone to be positioned so as to collect the data without being moved to a position where the data cannot be collected.

Referring again to FIG. 1, a system as disclosed herein may include a docking station 130. The docking station may provide wired and/or wireless connections to the head unit 110 and/or the wristband 120, such as to charge the other components. In some configurations, the docking station may include an inductive charging component that can provide electrical power to the head unit and/or to the wristband via matching inductive charging components in the head unit and/or wristband. In some configurations, the docking station also may include electrical connections to provide power to the head unit, the wristband or both. Power may be provided directly to the head unit, which then provides power to the wristband as previously described, or power may be provided directly to both the head unit and the wristband.

In some configurations, multiple wristbands may be used with a single head unit. Different wristbands may provide different functionality to the smart watch. For example, one wristband may include multiple sensors as previously described, while having a relatively small battery that is only used to power the sensors when the wristband is disconnected from the head unit. A second wristband may include no sensors or fewer sensors, but a larger battery than the first wristband. This battery may be used to provide additional power to the head unit when the two are connected, such as to provide backup power in the event the head unit battery is depleted. Similarly, different wristbands may include different sensors or different types of sensors, to allow for customization to specific use cases.

In some configurations, a smart watch as disclosed herein may be used in conjunction with other computing devices, such as a smart phone, a tablet computing device, and the like. For example, an application executing on the other computing device may be operated in conjunction with an application executing on the head unit, or it may receive data from the wristband directly or via the head unit.

In some configurations, the head unit may be capable of connecting to other appliances, computing devices, accessories, or the like. For example, the head unit may be connectable to an in-dash system of an automobile, to allow for the functionality of the head unit to be accessed while operating the automobile. As another example, the head unit may be connectable to other wearable accessories, such as a lanyard, a necklace or other item of jewelry, an item of apparel, or the like, to allow for functionality of the head unit to be accessed when it may be undesirable to wear a smart watch or similar device. As another example, a wristband may be customized for particular use cases, such as where a wristband includes a GPS receiver and a larger battery for use during camping or other wilderness activities. Similarly, different head units may be useable with a single wristband, such as where a user desired to upgrade the computing resources available in the head unit without changing the appearance and/or functionality of the wristband.

Other components than those specifically described herein may be included in the head unit and/or the wristband. For example, the head unit may include a vibrational component such as a motor to allow for “silent” operation as is used with smart phones and other devices. Similarly, the wristband may include a vibrational component or other similar component. Such a feature may be useful, for example, as an alarm when the wristband is worn without the head unit connected to the wristband.

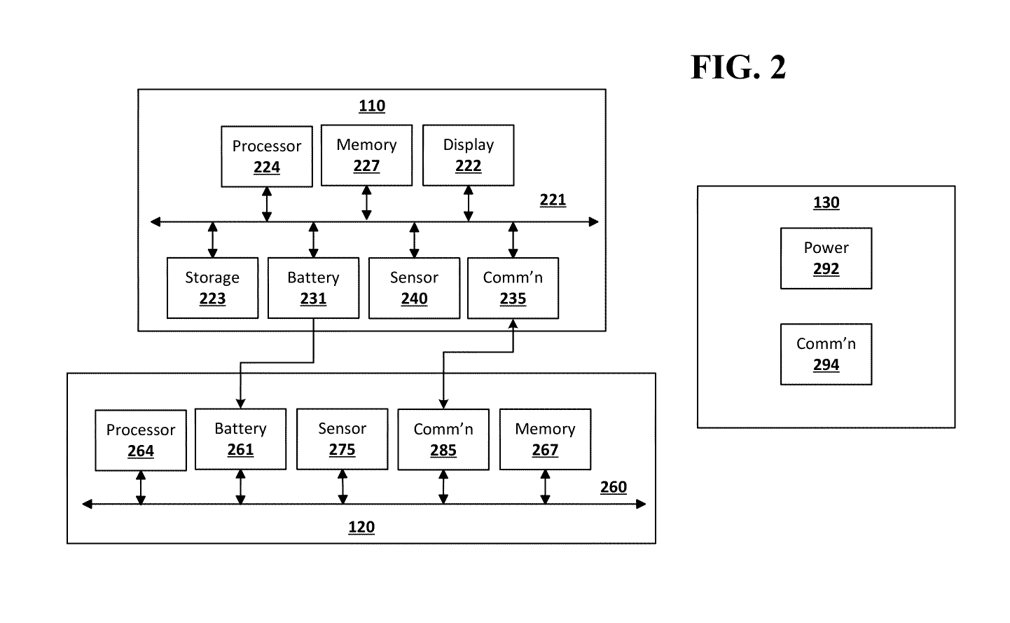

FIG. 2 shows a schematic representation of a smart watch head unit, wristband, and a docking station as disclosed herein. It will be understood that components other than those illustrated may be included, and that components shown may be omitted without deviating from the scope of the disclosed subject matter. A head unit 110 as previously described may include a bus 221 which interconnects major components of the head unit 110, such as a central processor 224, a memory 227 such as RAM, flash RAM, a user display 222, such as a display screen, and additional memory 223 such as a solid-state drive, flash storage, or the like. Power may be provided to tone or more of the various components via an internal battery 231, which may be charged via an external power connection as will be readily understood by one of skill in the art. The head unit 110 also may include one or more sensors 240 as previously described, such as biometric sensors, accelerometers, audio sensors, light sensors, and the like. A wired and/or wireless communication component 235 may allow the head unit to communicate with the wristband 120, a docking station, and/or other networked computing devices.

A wristband 120 may include a bus 260 that connects components such as a processor 264, memory 267, battery 271, and one or more sensors 275 as previously described. The wristband may communicate with the head unit 110 via a wired and/or wireless communication component 285 as previously described. Power may be provided by a battery 261, which may be charged by the battery 231 of the head unit as previously described.

As previously described, a docking station 130 as disclosed herein also may include a power source 292, such as an inductive charging component, that can provide power to the head unit 110 and/or the wristband 120. It also may include a data connection 294 capable of communicating with the head unit to provide additional dock functionality, such as additional connections to other computing devices, additional display or processing capabilities, or the like, as will be readily understood by one of skill in the art, as well as conventional computing components such as a processor, computer-readable memory, and the like.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system comprising:
a first wristband comprising a first sensor;
a head unit comprising a processor and a display, the head unit removably connected to the wristband; and
a docking station comprising a docking component configured to receive the head unit when the head unit is disconnected from the wristband.

2. The system of claim 1, wherein the first wristband further comprises a first battery.

3. The system of claim 2, wherein the head unit further comprises a second battery, the second battery having a larger capacity than the first battery.

4. The system of claim 1, wherein the first wristband comprises a plurality of sensors.

5. The system of claim 1, wherein the first wristband is configured to sync with the head unit when the head unit is connected to the wristband.

6. The system of claim 1, further comprising a second wristband, wherein the head unit is removably connectable to the second wristband.

7. The system of claim 6, wherein the second wristband comprises a second sensor of a different type than the first sensor.

8. The system of claim 6, wherein the first wristband comprises a first battery, and the second wristband comprises a second battery having a larger capacity than the first battery.

9. The system of claim 1, wherein the docking component comprises an inductive charging component.

10. The system of claim 9, wherein the head unit comprises an inductive charging component.

11. The system of claim 9, wherein the first wristband comprises an inductive charging component.

12. The system of claim 1, wherein the head unit comprises a wireless communication component.

13. The system of claim 1, wherein the first wristband is configured to monitor a biometric signal using the first sensor.

14. The system of claim 13, wherein the first wristband is further configured to store data received from the biometric signal when the first wristband is disconnected from the head unit, and to sync the data with the head unit upon the first wristband being reconnected to the head unit.

15. The system of claim 1, wherein the head unit comprises a charging component configured to provide power to the first wristband when the first wristband is connected to the head unit.

16. A smart watch component comprising:
a display;
a processor in communication with the display;
a computer-readable memory in communication with the processor; and
a communication component in communication with the processor;
wherein the communication component is configured to receive data from a wristband when the smart watch component is connected to the wristband.

17. The smart watch component of claim 16, further comprising a battery, wherein the smart watch component is configured to provide power from the battery to the wristband when the smart watch component is connected to the wristband.

18. The smart watch component of claim 16, wherein the data received from the wristband comprises sensor data obtained by a sensor in the wristband.
